(19) United States
(12) Patent Application Publication
(10) Pub. No.: US 2006/0003145 A1
(43) Pub. Date: Jan. 5, 2006

(54) Ultra-smooth microfabricated pores on a planar substrate for integrated patch-clamping

(76) Inventors: Carl L. Hansen, Pasadena, CA (US); Tobias Kippenberg, Hans-Kopf3ermann (DE)

Correspondence Address: DLA PIPER RUDNICK GRAY CARY US, LLP, 4365 EXECUTIVE DRIVE, SUITE 1100, SAN DIEGO, CA, 92121-2133, US

(21) Appl. No.: 11/052,619

(22) Filed: Feb. 4, 2005

Related U.S. Application Data
(60) Provisional application No. 60/542,179, filed on Feb. 4, 2004.

(51) Int. Cl. B32B 3/10

(52) U.S. Cl. 428/131

(57) ABSTRACT

Devices having ultra-smooth pores useful in patch clamping experiments, and methods for fabricating thereof are provided.

### CROSS REFERENCE TO RELATED APPLICATIONS

This application claims the benefit of priority under 35 U.S.C. § 119(e) of U.S. Ser. No. 60/542,179 filed Feb. 4, 2004, the entire content of which is incorporated herein by reference.

### BACKGROUND OF THE INVENTION

1. Field of the Invention

The present invention relates generally to the field of patch clamping technology, and more specifically, to devices having ultra-smooth pores useful in patch clamping experiments, and to methods for fabricating thereof.

2. Background Information

In the drug discovery studies, it is important to analyze the interaction of potential small molecule therapeutic agents with ion channels of a cell. To make sure that a potential drug does not adversely affect the ion channels, electrophysiological tests are conducted. These studies are known as patch clamping experiments. Typically, in patch clamping experiments the electrical activity in the membrane is evaluated by measuring voltage changes produced in response to exposure to various stimuli. In conventional patch clamping experiments, a cell is sealed against the end of a micro-capillary by aspiration. It is important to ensure intimate contact between the cell to the surface of the end of the micro-capillary so that the electrical resistance of the seal formed between the cell and the capillary is very high (at least several hundred megaohm up to one gigaohm or higher). Accordingly, the end of the capillary is treated to make the surface of the micro-capillary very smooth.

The conventional patch clamping methods require the surface of the capillary to be exceptionally smooth. The preparation of a suitable capillary is a time-consuming and labor intensive process. Moreover, since a capillary has only one orifice and is therefore capable of only forming a single seal at a time, the patch-clamping of cells can be a tedious and low-throughput process. Forming a seal a the end of a capillary requires precise mechanical and pressure manipulations so that even a technician who is highly skilled in the art can make only approximately 10 good quality seals in several hours. For this reason the use of patch-clamping to screen potential drug candidates for desirable/undesirable effects on membrane channels is limited.

In addition, it is desirable to integrate many suitable micropores on a single planar substrate for high throughput patch clamping. Planar substrates can be advantageous in that they are compatible with the integration of electronics elements necessary for patch-clamping, and are suitable for imaging. Moreover, the fabrication of many patch clamping orifices on a single planar substrate is compatible with the integration of microfluidic components on the top and bottom surfaces of the wafer to allow for efficient perfusion of cells with various chemical reagents. For the use of such micropores in planar patch-clamping experiments they need have geometries and surface properties that are compatible with the formation of high resistance cell-micropore seals.

In view of the foregoing, there exists a need to develop devices that allow for high-throughput patch-clamping experiments.

### SUMMARY OF THE INVENTION

According to an embodiment of the present invention, a device is provided, the device comprises a planar substrate, the substrate to include a plurality of micropores, where the micropores extend throughout the depth of the substrate and have root mean square roughness below about 10 nanometers.

According to another embodiment of the present invention, a method for fabricating a planar substrate comprising a plurality of micropores is provided, the substrate includes a silicon oxide layer disposed over a silicon layer, the method comprises forming a plurality of openings in the substrate, and subjecting the openings to radiation, such as laser-generated radiation, light source-generated radiation or locally applied heat source-generated radiation, to form the plurality of micropores having root mean square roughness below about 10 nanometers. The methods used for forming the opening in the substrate include photolithography and etching.

According to yet another embodiment of the present invention, a device for conducting patch clamping experiments is provided, the device includes a planar substrate comprising a plurality of micropores, wherein the micropores extend throughout the depth of the substrate and have root mean square roughness below about 10 nanometers, and cells disposed to the entrance of the micropores, where they form a seal having electrical impedance of at least 1 gigaohm.

### BRIEF DESCRIPTION OF THE DRAWINGS

FIGS. 1A-1C show schematically initial stages of the process leading to formation of micropores according to an embodiment of the present invention.

FIGS. 2A-2C show schematically final stages of the process leading to formation of micropores according to an embodiment of the present invention.

FIG. 3 shows schematically a micropore fabricated according to an embodiment of the present invention.

FIGS. 4A-4E show schematically the process of formation of micropores according to another embodiment of the present invention.

FIG. 5 shows schematically a micropore fabricated according to another embodiment of the present invention.

### DETAILED DESCRIPTION OF THE INVENTION

Terms, Definitions, and Abbreviations.

The following terminology, definitions, and abbreviations apply:

The term “substrate” can be defined as a planar base layer of a material that can include one to plurality of micropores.

The term “photoresist” can be defined as any radiation-sensitive material, for example, a material sensitive to ultra violet (UV) radiation.

The term “photomask” or “mask” can be defined as photolithographic device used to block the exposure of photoresist to UV radiation in selected areas.

The terms “opening,” “micropore” and “orifice” can be defined as an aperture or hole extending throughout the entire depth of a substrate.

The term “cylindrical” can be defined as a tri-dimensional surface generated by rotating a parallel line around a fixed line.

The term “frustoconical” can be defined as a tri-dimensional surface formed by cutting off and removing the top of a cone, where the cut can be either parallel or non-parallel to the bottom surface of the cone.

The term “roughness” can be defined as a parameter characterizing the degree of smoothness of a surface. For the purposes of the present invention, roughness can be characterized as root mean square (“rms”) roughness which is determined according to formula (I):

$${σ}_{s} = \sqrt{\frac{1}{n} {\sum }_{x = 0}^{N} {[ s ( x ) - \overline{s ( x )} ]}^{2}} \qquad ( I )$$

where s(x) is the surface height a point x in the surface profile and s\overline{(x) is} the average height of the surface profile.

### Embodiments of the Invention

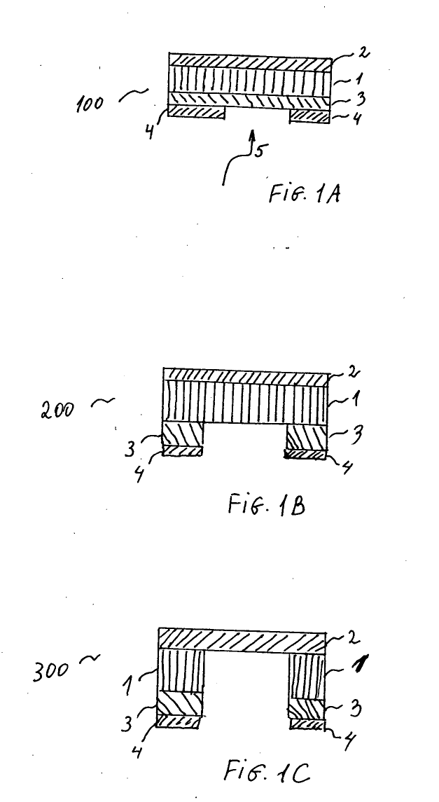

According to one embodiment of the invention, a method for fabricating a device having a substrate and a plurality of ultra-smooth pores is provided. The method and the device can be illustrated with the reference to FIGS. 1A-1C, 2A-2C, and 3.

FIG. 1A is a schematic illustration showing a cross-section of a structure 100. The structure 100 includes a substrate 1, which can be made of any material that provides electrical isolation and that can be micromachined using microengineering techniques, including, but not limited to, such techniques as laser ablation, isotropic etching, selective etching, reactive ion etching, ion track milling, focus ion beam milling, electrical discharge machining, or embossing. For example, the substrate can be made of semiconductor materials for which a variety of micromachining techniques, including those described above, are well established. One example of a particular material that can be used for making substrate 1 includes crystalline or polycrystalline silicon. The substrate can have the thickness between about 100 μm and 1 mm.

Over substrate 1, there can be disposed a layer 2 of a second material. The second material that can be used includes any material which can be micromachined and then locally melted and reflowed as described below. Any micromachining technique known in the art can be used for micromachining the second material, including but not limited to, the techniques described above.

Examples of a material that can be used to make layer 2 include various silicon oxide based glasses, quartz, or a suitable polymer. Any type of glass used to make micro-capillaries in traditional patch-clamping experiments can be used, for example, borosilicate crown and soda lime glass.

Silicon oxide layer 2 can be formed using standard techniques known to those skilled in the art, including but not limited to, wafer-bonding, thermal oxide growth, or sputtering. Silicon oxide layer 2 can have the thickness between about 0.2 μm and 10 μm. As a result, a silicon/silicon oxide wafer can be fabricated. Alternatively, suitable silicon/silicone oxide substrates can be obtained from a variety of commercially sources, e.g., from such suppliers as Silicon Valley Microelecronics, Montco, or Virginia Semiconductors.

The silicon/silicon oxide wafer can be thoroughly cleaned in preparation for further processing. Any suitable method of cleaning used in the semiconductor fabrication technologies can be employed, such as multiple washing in de-ionized water or in a solvent, e.g., ethanol or acetone, followed by drying. The substrate can then be patterned using techniques that are well known in the art including, but not limited to photolithography, ion-beam lithography, electron beam lithography, direct write laser lithography, micro-contact lithography or embossing. In the example of photolithography, a layer of photoresist 3 can be deposited on the silicon side of the wafer, i.e., be deposited over the silicon layer 1. Any photoresist known in the art of semiconductor fabrication can be used. For example, FIG. 1A shows a positive photoresist, but a negative photoresist can be used alternatively, if desired.

The photoresist layer 3 can be prepared by dissolving a polymer, a photosensitizer, and a catalyst in a solvent to make a photoresist solution, followed by depositing the photoresist solution over the silicon layer 1, and baking, to make the layer 3. Any method known in the art of semiconductor fabrication can be used for depositing the photoresist solution. For example, the spin coating method can be used, typically involving spinning speeds of between about 1,000 and about 5,000 revolutions per minute, for about 30 to 60 seconds, resulting in the thickness of wet photoresist layer 3 ranging between about 0.1 μm and about 10 μm. The photoresist can typically contain polymer, solvent, photo-sensitive components, and other chemical additives. Those having ordinary skill in the art can select the proper composition of the photoresist required to create high resolution patterns, as known in the art.

Following the formation of the photoresist layer 3, to complete the formation of the structure 100, a photomask 4 can be applied over the photoresist layer 3 in such as way as to cover a portion of the photoresist layer 3, while leaving another portion of the photoresist layer uncovered as shown on FIG. 1A. The mask 4 can be applied using standard techniques and materials used in semiconductor fabrication industry and known to those having ordinary skill in the art. For example, the mask can be a glass plane having patterned emulsion or metal film on one side. Alternatively, a sacrificial photoresist layer could be used to deposit a patterned thin film, (e.g., chrome), directly on the substrate for use as an etch-mask. This layer would protect selected regions of the substrate during subsequent processing and could subsequently be removed by chemical or alternative means once this function has been accomplished.

In case that a simple photomask procedure is used, ultra violet (UV) radiation 5 can then be directed at the photoresist layer 3 as shown by FIG. 1A. The wavelength of the UV radiation can be chosen to match the properties of the specific photoresist that is used and can be about 365 nm. The total power of the UV exposure can be selected to provide the best fidelity in the reproduction of patterned features. The UV radiation can be generated by any standard commercially available source, to be selected by those having ordinary skill in the art.

As a result of the exposure to the UV radiation, the exposed portion of the photoresist layer 3 is destroyed and removed, leaving the structure 200 shown by FIG. 1B. As can be seen, the structure 1B comprises the silicon layer 1 and the silicon oxide layer 2. A portion of the silicon layer 1 has been now revealed. The exposed portion of the silicon layer 1 is the portion underlying the area from which a portion of the photoresist layer 3 has been removed.

The structure 200 shown by FIG. 1B can then be etched to remove the exposed portion of the silicon layer 1, to form the structure 300 shown by FIG. 1C. The entire exposed portion of the silicon layer 1 can be removed so that a portion of the silicon oxide layer 2 has become exposed.

Any method of etching known in the art of semiconductor fabrication for etching silicon can be used. For example, wet etching using such etching agent as potassium hydroxide can be utilized. Alternatively, dry etching can be used, for example, plasma etching, sputter etching, ion milling, ion-track milling, reactive ion etching or deep reactive ion etching.

As a result of processing the wafer described above, the structure 300 shown by FIG. 1C can be obtained. As can be seen, the structure 300 includes photolithografically defined wells (one of which is shown by FIG. 1C), extending throughout the silicon layer 1 and terminating at the silicon oxide layer 2. Following the etching procedure, if desired, the remainder of the photomask layer 4 and the photoresist layer 3 can be removed (not shown) using standard techniques.

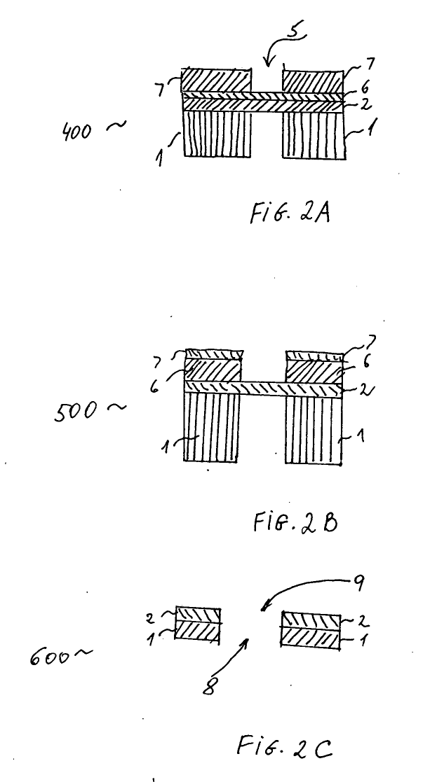

The silicon oxide layer may then be patterned and selectively etched using techniques similar to those described above. For example, in the case of photolithography, the wafer can be then further processed as illustrated by FIGS. 2A-2C. A photoresist layer 6 can be deposited over the silicon oxide layer 2. Any photoresist known in the art of semiconductor fabrication can be used, and the above-described methods can be used for forming the photoresist layer 6. A photomask layer 7 can be applied over the photoresist layer 6 in such as way as to cover a portion of the photoresist layer 6, while leaving another portion of the photoresist layer 6 uncovered as shown on FIG. 2A.

The photomask layer 7 can be applied in such a way as to have the uncovered portions of the photoresist layer 6 aligned with photolithografically defined wells formed in the silicon layer 1, as described above. The mask 7 can be applied using standard techniques and materials used in semiconductor fabrication industry and known to those having ordinary skill in the art, as described above.

The structure 400 shown by FIG. 2A can then be further processed to obtain the structure 500 shown by FIG. 2B. To this end, UV radiation 5 can be directed at the photoresist layer 6 as shown by FIG. 2A. The parameters of UV radiation, and the equipment used to generate the same can be as described above. As a result of the exposure to the UV radiation, the exposed portion of the photoresist layer 6 is destroyed and removed, leaving the structure 500 shown by FIG. 2B. The structure 500 comprises the silicon layer 1 and the silicon oxide layer 2. A portion of the silicon oxide layer 2 has been now exposed on both sides.

The structure 500 shown by FIG. 2B can then be etched to remove the exposed portion of the silicon oxide layer 2, to form the structure 600 shown by FIG. 2C. The entire exposed portion of the silicon oxide layer 2 can be removed. Any above-described method of etching can be used. For wet etching, a common etching agent typically employed for etching silicon oxide can be used. Such etching agents are well known to those having ordinary skill in the art. For example, a solution containing hydrofluoric acid, known in the art as “buffered oxide etchant” can be used.

The remainder of the photoresist layer 6 and of the photomask layer 7 can be also removed using conventional techniques. As shown by FIG. 2C, the structure 600 comprises the silicon layer 1, and the silicon oxide layer 2. Structure 600 contains an opening 8 extending throughout the entire depth of the structure 600.

The cross-sectional area of the opening need not be constant, and may change abruptly at the interface between the silicon and the silicon oxide due to the separate procedures in patterning and etching the two sides of the structure. In particular it is advantageous to make the cross-section of the opening in the silicon larger than the opening in the silicon oxide. This results in the isolation of the silicon oxide in the vicinity of the opening from the silicon and consequently improves its thermal isolation. This thermal isolation consequently facilitate the reflow of the silicon oxide in the vicinity of the pore by the application of a laser pulse as described below.

It should also be noted that the steps required to pattern and etch the two sides need not be done in the order described in the illustrative example above. For instance the silicon oxide patterning and etching step could be executed prior to processing the silicon side. While standard micromachining procedures can be sufficient for creating a series of micropores in a planar substrate, further processing can be needed to make the micropores having the shape and the degree of smoothness suitable for generating a high-quality seal.

In the additional processing procedure, radiation can be applied to cause the reflow of the material in the vicinity of the aperture 8. Any suitable source can be used for generating radiation, so long as the energy generated by the source is sufficient to bring about the reflow of the material. For instance, sources of generation can include a laser, a light radiation source (e.g., flash bulbs in a thermal annealer), or a locally applied heat source.

In an exemplary embodiment, laser radiation 9 can be applied by focusing the radiation to a small area and directed at the aperture 8. FIG. 2C shows that the laser radiation is delivered from the side of the silicon oxide layer 2. Alternatively, it can be delivered from the opposite side (i.e., the side of the silicon layer 1) as long as power from the laser is delivered to the material defining the pore opening 8. Those having ordinary skill in the art will understand that the choice of the type of laser that can be used will depend on characteristics of the material used to fabricate the micropores. The absorbance of the material that can be used can be such that the laser would be able to deliver significant quantity of power to the material. The term “significant quantity of power” can be defined as the amount of power necessary to melt the material locally, and depends on the material used, the size of the focused laser beam, and the geometry of the fabricated micropore.

One kind of laser that can be used is a carbon oxide laser. This laser is well suited to the processing of pores made from silicon oxide due to the high absorbance of this material at wavelengths near ten microns where the laser has significant power. Any type of commercially available carbon oxide laser can be also used. The choice of laser types depends on the characteristics of the material used to fabricate the pores. The absorbance of the material must be such that the laser can deliver significant power to the material, where significant power is defined as the power necessary to melt the material locally, and depends on the material and geometry of the fabricated micropore.

Other types of lasers that can be used include gas lasers such as argon-ion or krypton, solid state lasers such as Nd:YAG, or diode lasers. The fluence and exposure time delivered by the laser is chosen to be sufficient to locally melt the micro-pore material, and as mentioned above depends on the properties of the fabricated micro-pore including the thermal conductivity of the material, the geometry of the pore, the absorbance of the pore, the thermal conductivity of the underlying substrate, and the heat capacity of the fabricated pore and the substrate, and the melting temperature of the micro-pore.

For example, in the case of a micro-pore fabricated from a film of silicon oxide having a thickness of about 2 μm, a carbon oxide gas laser with total output power of between 1 and 20 Watts, and focused to a spot size having the diameter between 20-200 μm, the necessary exposure time to locally reflow the silicon oxide can be between 1 and 1000 ms. Such exposure time can lead to selective melting and reflowing of silicon oxide. The reflow causes the silicon oxide in the vicinity of the pore to adopt a very smooth and rounded shape that is determined by surface tension effects. This results in an opening that has an optimal rounded shape for patch-clamping, and that can be extremely smooth (typically a surface root mean square of less than 3 nm), making it suitable for the formation of high-quality seals.

Additionally, the selective reflow achieved through the application of laser radiation can be used to modify both the shape and the diameter of the micro-pore opening. As the reflow progresses, surface tension effects can be used to shrink or expand the diameter of the opening. The shrinking or expansion of the diameter of the opening depends on the laser radiation parameters including pulse duration, wavelength, exposure area, and power, and on the geometry of the opening. Those having ordinary skill in the art can determine, empirically or theoretically, the necessary conditions required to achieve the desired final pore diameter and shape, e.g. to make possible the fabrication holes of higher perfection and smaller diameter than is possible with conventional micromachining techniques.

The reflow of the pore structure can further be implemented in a feed-back mode by monitoring the light that passes through the pore. As the pore shrink in diameter the pattern of light that passes by refraction, transmission, and scattering through the hole will change. By monitoring this light, for instance using a photo-diode or a charge coupled device camera, it is possible to monitor the progression of the reflow and shrinking process. Once the desired pore features are achieved the laser radiation treatment can be terminated.

As a result of the treatment illustrated by FIGS. 1A-1C and 2A-2C, a substrate of the present invention can be formed. The substrate is shown by FIG. 3 as structure 600. The substrate includes the silicon layer 1 and the silicon oxide layer 2 disposed over the silicon layer 1, and comprises a substantially cylindrical micropore 8 extending throughout the entire depth of the structure 600 with an opening that has been rounded and smoothed by localized reflow of the silicon oxide achieved through the application of suitable laser radiation. The diameter of the micropore 8 can be between about 0.5 and 10.0 μm. The micropore 8 has an ultra-smooth surface which can have the roughness of about 10 nanometers rms, or less, for example, about 3 nanometers rms or less. The roughness of the inner surface of the micropore 8 can be measured using common microscopy techniques. For example, the method of electron microscopy can be used, as known to those having ordinary skill in the art.

FIG. 3 shows the micropore 8 as being substantially cylindrical. Alternatively, the micropore 8 can be slightly tapered and be formed in frustoconical shape. Those having ordinary skill in the art can make the orifice in the desirable shape by varying the etching methods, the fluence and the duration of the laser exposure, and the parameters of the reflowing process. For instance, if anisotropic etching of the silicon layer 1 is used, the shape of the micropore 8 can be that of a truncated square pyramid.

FIG. 3 shows merely an exemplary substrate having only one micropore 8. However, many similar or identical orifices can be formed on the same substrate, if desired. For example, if a large opening through the silicon is made, a plurality of micropores through the silicon oxide layer 2 may be fabricated. All the micropores in the plurality can intersect with the same opening in the silicon layer 1, forming a single inlet through the silicon layer 1 connected to a plurality of inlets through the silicon oxide layer 2. In such geometry, the distance between the centers of adjacent micropores can be limited only by the thermal isolation between the pores and the ability to focus the laser used to implement the reflow.

The distance between the centers of adjacent micropores can be between about 10 and about 50 μm, corresponding to the density of the micropores between about 40,000 and 1,000,000 micropores per square centimeter of the surface of the substrate 600. If it is desired to have every micropore connected to a unique opening in the silicon substrate 1 (for example, for electrical addressability), the density of pores can be limited by the minimal size of opening that can be made through the silicon substrate 1. A reasonable size of opening to be fabricated through a 1 mm thick silicon substrate 1 can be approximately 100 μm. This size would correspond to an achievable density of micropores ranging from about 1,000 to 10,000 per square centimeter. These parameters are intended as illustrative examples of achievable density and it is understood that higher and lower densities may be both achievable and desirable.

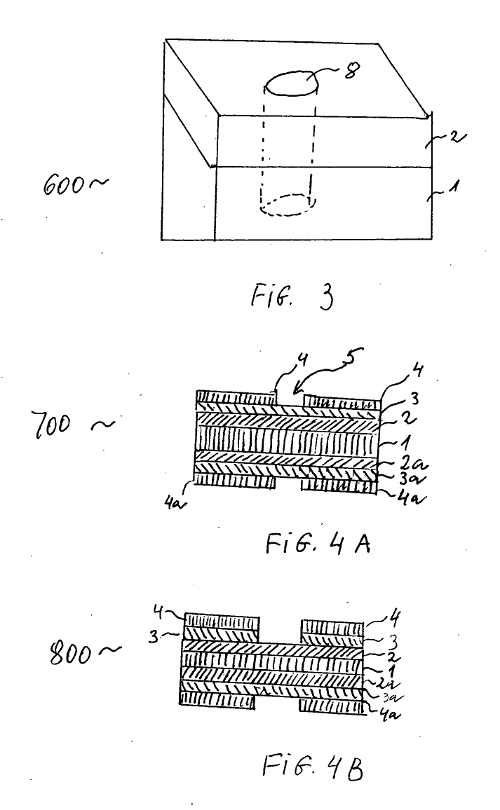

In accordance with one embodiment of the invention, a method for fabricating another device having a substrate and a plurality of ultra-smooth pores is provided. The method and the device can be illustrated with the reference to FIGS. 4A-4C, 5A-5C, and 6.

FIG. 4A is a schematic illustration showing a cross-section of a structure 700. The structure 100 includes a substrate 1, which can be made of silicon. The thickness of the silicon substrate 1 can be as described above. Two layers 2 and 2a, each comprising silicon oxide, are disposed over the silicon substrate 1, so that the silicon substrate 1 is sandwiched between the two silicon oxide layers 2 and 2a. Each of the silicon oxide layers 2 and 2a can have the thickness as described above. Again, each of the silicon oxide layers 2 and 2a can utilize any suitable form of silicon oxide to be selected by those having ordinary skill in the art, such as glass.

The silicon oxide/silicon/silicon oxide wafer can be thoroughly cleaned as described above. Two layers of photoresist 3 and 3a can be then deposited over each of the silicon oxide layers 2 and 2a, respectively. Any photoresist known in the art of semiconductor fabrication can be used. For example, any photoresist described above can be used. The methods of formation of photoresist layers known to those having ordinary skill in the art can be used, as described above.

Following the formation of the photoresist layers 3 and 3a, two photomasks 4 and 4a can be applied over the photoresist layers 3 and 3a, so that a portion of the photoresist layer 3 and a portion of the photoresist layer 3a are covered, while leaving other portions of the photoresist layers 3 and 3a uncovered. The two photomasks 4 and 4a are applied in such a way that the uncovered portions of the photoresist layers 3 and 3a are aligned, as shown on FIG. 4A. The photomasks 4 and 4a can be applied using standard techniques and materials, as described above.

UV radiation 5 can then be directed at the photoresist layer 3 as shown by FIG. 4A. The wavelength, and the duration of the exposure can be the same as above. As a result of the exposure, the exposed portion of the photoresist layer 3 is destroyed and removed, leaving the structure 800 shown by FIG. 4B. The structure 800 comprises the silicon oxide layer 2, a portion of which has been exposed.

The structure 800 shown by FIG. 4B can then be etched to remove the exposed portion of the silicon oxide layer 2, to form the structure 900 shown by FIG. 4C. The entire exposed portion of the silicon oxide layer 2 can be removed. Any above-described method of etching can be used, for example, wet etching using a solution of hydrofluoric acid. As a result, the structure 900 shown by FIG. 4C includes the silicon layer 1, a portion of which has been exposed from one side.

UV radiation 5 can then be directed at the photoresist layer 3a as shown by FIG. 4C. The parameters of the UV exposure (i.e., the wavelength, the duration) the exposure can be the same as above. As a result of the exposure, the exposed portion of the photoresist layer 3a is destroyed and removed, leaving the structure 1000 shown by FIG. 4D. The structure 1000 comprises the silicon layer 1, a portion of which has been exposed from one side, and the silicon oxide layer 2a, a portion of which has been exposed also from one side.

The structure 1000 shown by FIG. 4D can then be etched to remove the exposed portion of the silicon oxide layer 2a, followed by etching and removing the exposed portion of the silicon layer 1; alternatively, the exposed portion of the silicon layer 1 can be etched and removed first, followed by etching and removing the exposed portion of the silicon oxide layer 2a. Etching can be conducted as described above. For example, if wet etching is selected, the exposed portion of the silicon layer 1 can be etched using a solution of potassium hydroxide, and the exposed portion of the silicon oxide layer 2a can be etched using a solution of hydrofluoric acid.

The remainder of the photoresist layers 3 and 3a and of the photomask layers 4 and 4a can be also removed using conventional techniques. As shown by FIG. 4E, the structure 1100 comprises the silicon layer 1 sandwiched between the silicon oxide layers 2 and 2a. Structure 1100 contains an opening 8 extending throughout the entire depth of the structure 1100.

For further processing, laser radiation 9 can be directed at the aperture 8. FIG. 4E shows that the laser radiation is delivered from the side of the silicon oxide layer 2. Alternatively, it can be delivered from the opposite side, i.e., the side of the silicon oxide layer 2a, as long as the radiation enters the opening 8. The laser radiation having the same parameters as those described above can be utilized. The application of laser treatment leads to selective melting and reflowing of silicon oxide, thus resulting in the aperture 8 having a high degree of smoothness.

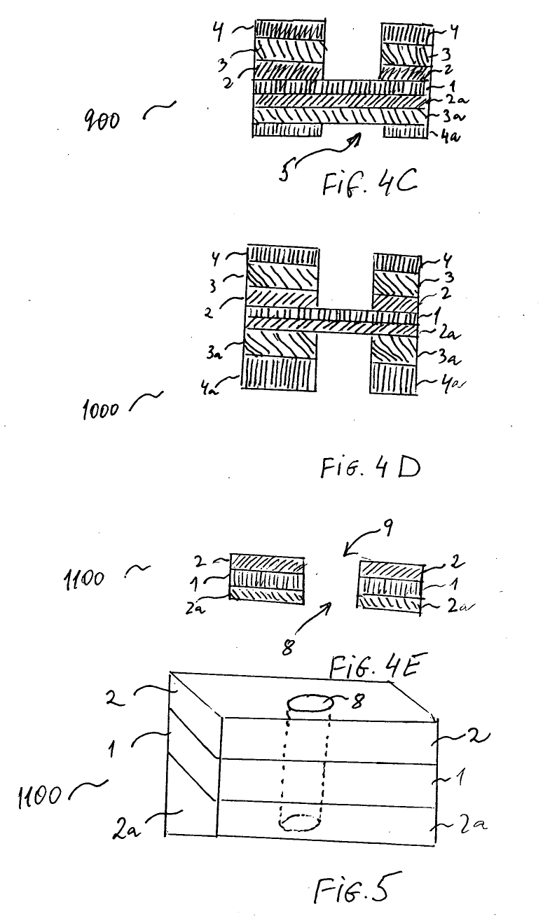

As a result of the treatment illustrated by FIGS. 4A-4E, a substrate according to an embodiment of the present invention can be formed. The substrate is shown by FIG. 5. The substrate includes the silicon layer 1 disposed between the two silicon oxide layers 2 and 2a, and comprises a substantially cylindrical micropore 8 extending throughout the entire depth of the structure 1100. The diameter of the micropore 8 can be as described above. If wet etching of the silicon layer 1 is employed, the shape of the micropore 8 can be that of a truncated rectangular prism or a square trench, that intersects with the smooth rounded opening formed in silicon oxide, instead of a cylinder shown by FIG. 5.

The opening of micropore 8 has an ultra-smooth surface which can have the roughness as described above, i.e., about 10 nanometers rms, or less, e.g., about 3 nanometers rms or less. FIG. 5 shows the micropore 8 as being substantially cylindrical, but as before, the micropore 8 can be slightly tapered. Those having ordinary skill in the art can make the orifice in the desirable shape by varying the etching methods, and the fluence and the duration of the laser exposure. A plurality of micropores 8 can be formed in a similar way, where the distance between the individual micropores, as well as their density can be as described above.

In the above example the selective reflow/melting is achieved using the application of focused laser radiation. Alternative techniques for heating or reflow that can be used include the application of a locally heated probe, the global heating of the whole substrate, or the partial dissolution of the surface material using a chemical solvent.

A substrate having the micropore(s) with the opening having ultra-smooth surface obtained according to embodiments described above can be then used for conducting patch clamping experiments. Cells can be positioned in the opening(s) of the micropore(s) 8. To place the cells in the opening(s) of the micropore(s) 8, a substrate having the micropore(s) 8, e.g., a solution containing cells can be dispensed onto the substrate illustrated by FIG. 3 or 5, or a commonly used microfluidic device can be used to allow delivery of the cells to the immediate vicinity of the micropore(s) 8. By applying negative hydrodynamic/hydrostatic pressure across the micropore(s) 8, a flow can be induced through the micropore(s) 8, bringing the cells to the opening(s) of the micropore(s) 8. By aspiration, the cells can be captured in the ultra-smooth opening(s) of the micropore(s) 8, where they can form a high impedance seal. Alternatively, the cells may be positioned near the pore openings using more direct means, e.g., optical tweezers, where the cells can be captured in the opening(s) of the micropore(s) 8 by gentle aspiration.

Additionally, once the cells are captured at the opening(s) of the micropore(s) 8, a micromechanical actuator positioned above the cells can be used to apply a force causing the cells to be pushed against the surface of the micropore(s) 8. This applied force may be used to cause the cells to flatten against the ultra-smooth inside surface of the micropore(s) 8. Thus, the area of the seal, and hence the impedance of the seal, can be increased. The pressure can be applied in a variety of ways, for example, hydrodynamically (using a hydrodynamic jet), or mechanically (using a deflected membrane integrated in an elastomer flow structure above the orifice, or using another mechanical actuator).

If the deflected membrane method is to be employed, an elastomer membrane that separates the flow structure in intimate contact with the pores from a separate and fluidically isolated channel structure may be used. The application of pneumatic or hydraulic pressure to the isolated flow structure may be used to cause the membrane to deflect into the primary flow structure, pressing the cell down against the pore. The fabrication of such membranes is well known to those having ordinary skill the art.

The seal contact area can be approximated as an annulus (i.e., the area between two concentric circles). The outer diameter of the annulus can be enlarged thus increasing the area of the seal. To enlarge the outer diameter of the annulus can be achieved by increasing the pressure applied through the mechanical actuator to the cell from top of the substrate downwardly.

The application of pressure during the formation of the seal can continue until the high impedance of the seal has been reached indicating that the area of the seal has become sufficient. To determine the sufficiency of the seal, the impedance of the seal is continually or intermittently monitored using the methods of monitoring known to those having ordinary skill in the art. One indication of the fact that the seal has become sufficient is when the impedance of the seal has reached about 1 gigaohm or higher.

The following example is intended to illustrate but not limit the invention.

### EXAMPLE 1

### Fabrication of Ultra-Smooth Pores

A thermally oxidized silicon wafer, having the thickness of about 380 micron, double sided polished, can be used as a substrate. First, the backside of the wafer can be processed. Using photolithography and anisotropic silicon etching, pyramid shaped pits can be etched. Etching proceeds until the pyramid is in contact with the silica from the front side of the wafer, creating a pyramidic pit, which is capped with the oxide from the front layer (leaving a square oxide window at the end of the pit of about 30 μm width).

Subsequently, lithography and etching can be used on the frontside of the wafer only, since the backside is protected by photoresist, and a circular opening can be etched in the center of the oxide capping the pit. In order to create a toroidally shaped pore, with ultra-smooth roughness, a laser assisted reflow can be used. The reflow can use a 10-11 micron wavelength laser such as a CO₂ laser). The silica openings at the end of the pits can be surface-norma irradiated (i.e., direction of light is perpendicular to the plane of the substrate) using the CO₂ laser, using approximately 1 W of power (100 micron-beam diameter). The subsequent melting of the glass, causes the surface tension to create a toroidally shaped circular seal (pore) with roughness of less than about 10 nm root means square.

Although the invention has been described with reference to the above example, it will be understood that modifications and variations are encompassed within the spirit and scope of the invention. Accordingly, the invention is limited only by the following claims.

What is claimed is:

1. A device comprising a planar substrate, the substrate comprising a plurality of micropores, wherein the micropores extend throughout the depth of the substrate and have root mean square roughness below about 10 nanometers.

2. The device of claim 1, wherein the substrate is fabricated of a semiconductor material or a polymer.

3. The device of claim 2, wherein the semiconductor material is silicon.

4. The device of claim 3, comprising a first silicon oxide layer disposed over a first side of a silicon layer.

5. The device of claim 4, further comprising a second silicon oxide layer disposed over a second side of the silicon layer, so that the silicon layer is sandwiched between the first silicon oxide layer and the second silicon oxide layer.

6. The device of claim 1, wherein the plurality includes between about 40,000 and 1,000,000 micropores per square centimeter of the surface of the substrate.

7. The device of claim 1, wherein the diameter of the micropores is between about 0.5 and 10.0 micrometers.

8. The device of claim 1, wherein the distance between the centers of adjacent micropores is between about 10 and about 50 micrometers.

9. A method for fabricating a planar substrate comprising a plurality of micropores, the substrate including a first layer disposed over a first side of a silicon layer, the first layer fabricated of a material selected from a silicon oxide and a polymer, the method comprising:
(a) forming a plurality of openings in the substrate; and
(b) causing a reflow of a material in the vicinity of the openings to form the plurality of micropores having root mean square roughness below about 10 nanometers.

10. The method of claim 9, wherein the reflow is caused by subjecting the openings to radiation generated by a source selected from a group consisting of a laser, a light radiation source and a locally applied heat source.

11. The method of claim 9, wherein the first layer is fabricated of a silicon oxide to form a first silicon oxide layer, and wherein forming a plurality of openings in the substrate comprises consecutively removing portions of the silicon layer and portions of the silicon oxide layer to form a plurality of orifices extending throughout the depth of the substrate.

12. The method of claim 11, wherein removing the portions of the first silicon layer comprises photolithography and etching.

13. The method of claim 11, wherein removing the portions of the first silicon layer comprises:
(a) forming a first photoresist layer disposed over the silicon layer;
(b) forming a first photomask disposed over the first photoresist layer, the first photomask having a plurality of openings;
(c) removing portions of the first photoresist layer underlying the openings in the first photomask to reveal the underlying areas of the silicon layer; and
(d) removing the revealed portions of the silicon layer by etching.

14. The method of claim 13, wherein the portions of the first photoresist layer are removed by subjecting the portions of the first photoresist layer to ultraviolet radiation.

15. The method of claim 13, wherein the etching is selected from a group consisting of the wet etching and dry etching.

16. The method of claim 11, wherein removing the portions of the first silicon oxide layer comprises photolithography and etching.

17. The method of claim 16, wherein removing the portions of the first silicon oxide layer comprises:
(a) forming a second photoresist layer disposed over the first silicon oxide layer;
(b) forming a second photomask disposed over the second photoresist layer, the second photomask having a plurality of openings, wherein the locations of the openings in the second photomask correspond to the removed portions of the silicon layer;
(c) removing portions of the second photoresist layer underlying the openings in the second photomask to reveal portions of the first silicon oxide layer; and
(d) removing the revealed portions of the first silicon oxide layer by etching.

18. The method of claim 17, wherein the portions of the second photoresist layer are removed by subjecting the portion of the second photoresist layer to ultraviolet radiation.

19. The method of claim 10, wherein the laser is selected from a group consisting of a gas laser, a solid state laser, and a diode laser.

20. The method of claim 19, wherein the gas laser is selected from a group consisting of a carbon oxide laser, argon-ion laser, and a krypton laser.

21. The method of claim 19, wherein the solid state laser is Nd:YAG laser.

22. The method of claim 11, wherein the substrate further comprises a second silicon oxide layer disposed over a second side of the silicon layer, so that the silicon layer is sandwiched between the first silicon oxide layer and the second silicon oxide layer.

23. The method of claim 22, wherein forming a plurality of openings in the substrate comprises consecutively removing portions of the first silicon oxide layer, portions of the silicon layer and portions of the second silicon oxide layer to form a plurality of substantially cylindrical orifices extending throughout the depth of the substrate.

24. The method of claim 23, wherein removing the portions of the first silicon oxide layer comprises photolithography and etching.

25. The method of claim 24, wherein removing the portions of the first silicon oxide layer comprises:
(a) forming a first photoresist layer disposed over the first silicon oxide layer;
(b) forming a first photomask disposed over the first photoresist layer, the first photomask having a plurality of openings;
(c) removing portions of the first photoresist layer underlying the openings in the first photomask to reveal portions of the first silicon oxide layer; and
(d) removing the revealed portions of the first silicon oxide layer by etching.

26. The method of claim 25, wherein the portion of the first photoresist layer is removed by subjecting the portions of the first photoresist layer to ultraviolet radiation.

27. The method of claim 25, wherein removing the portions of the silicon layer comprises etching the areas of the silicon layer underlying the removed portions of the first silicon oxide layer.

28. The method of claim 23, wherein removing the portions of the second silicon oxide layer comprises:
(a) forming a second photoresist layer disposed over the second silicon oxide layer;
(b) forming a second photomask disposed over the second photoresist layer, the second photomask having a plurality of openings, wherein the locations of the openings in the second photomask correspond to the removed portions of the silicon layer;
(c) removing portions of the second photoresist layer underlying the openings in the second photomask to reveal portions of the second silicon oxide layer; and
(d) removing the revealed portions of the second silicon oxide layer by etching.

29. The method of claim 28, wherein the portions of the second photoresist layer is removed by subjecting the portions of the second photoresist layer to ultraviolet radiation.

30. A device for conducting patch clamping experiments, the device comprising:
(a) a planar substrate comprising a plurality of micropores, wherein the micropores extend throughout the depth of the substrate and have root mean square roughness below 10 nanometers; and
(b) cells disposed inside the micropores,
wherein the cells are attached to the inside of the micropores to form a seal having electrical impedance of at least 1 gigaohm.

31. A method for fabricating a device for conducting patch clamping experiments, the method comprising:
(a) fabricating a planar substrate comprising a plurality of micropores according to claim 9;
(b) directing a liquid containing cells to the micropores; and
(c) hydraulically exerting positive pressure onto the liquid to trap the cells in the micropores to fabricate device thereby.
